(19) United States
(12) Patent Application Publication
(10) Pub. No.: US 2008/0281992 A1
(43) Pub. Date: Nov. 13, 2008

(54) METHOD FOR DETECTING ORDER OF ATTACHED DEVICES AND COMPUTER READABLE STORAGE MEDIA STORING PROGRAM THEREOF

(75) Inventor: Shih-Hsin Hsu, Taipei City (TW)

Correspondence Address: J C PATENTS, INC., 4 VENTURE, SUITE 250, IRVINE, CA, 92618, US

(73) Assignee: INVENTEC CORPORATION, Taipei City (TW)

(21) Appl. No.: 11/774,734

(22) Filed: Jul. 9, 2007

(30) Foreign Application Priority Data
May 11, 2007 (TW) 96116839

(51) Int. Cl. G06F 3/00

(52) U.S. Cl. 710/4

(57) ABSTRACT

A method for detecting the order of attached devices and a storage device for storing a program executing the same are provided. The method includes following steps. An inquiry is issued to obtain the device information of a plurality of attached devices, and one of the device information is selected. Whether the selected device information contains an attached device address is determined. If the selected device information contains an attached device address, the next device information is selected according to the attached device address. The order in which the device information is selected is recorded as the order of these attached devices.

### CROSS-REFERENCE TO RELATED APPLICATION

This application claims the priority benefit of Taiwan application serial no. 96116839, filed on May 11, 2007. All disclosure of the Taiwan application is incorporated herein by reference.

### BACKGROUND OF THE INVENTION

1. Field of the Invention

The present invention generally relates to a computer system, in particular, to a method for detecting the order of a plurality of attached devices in a computer system and a storage device for storing a program executing the same.

2. Description of Related Art

In today's IT industry, the demand to hard disks (for example, in a computer server) has been increased continuously along with the development of network technology. A redundant array of independent disks (RAID) which supports hot swapping technique is usually used in a computer server to provide high-standard and accurate data storage. Presently, external storage devices are usually used by mainframe servers for the convenience of subsequent data processing. Such a storage device has an enclosure management (EM) device and a backplane (BP) device according to the present specification thereof, wherein the EM device is used for controlling and managing the statuses (for, the temperature, fan speed, power supply, and voltage) of the storage device, while the BP device is connected to a hard disk for controlling the hot swapping function of the hard disk. A daughter card is installed to a server and a plurality of foregoing storage devices are attached externally to the daughter card through serial attached SCSI (SAS) technique, so that enough hard disk capacity can be provided.

According to conventional techniques, foregoing storage devices are out-of-order and hard disks may not appear in the same order as the storage devices to which they are attached in a management system, such as an operating system (OS), which is very confusing and inconvenient to use. For example, it is observed from the OS that the third hard disk in a first storage device is damaged, but actually the damaged hard disk is the third hard disk in a third storage device, which is confusing and difficult to manage. Presently, the problem described above cannot be resolved from hardware part because it is impossible for a daughter card manufacturer and a control chip manufacturer to provide a firmware for solving forgoing problem for each particular computer system.

Presently, to resolve foregoing problem in a daughter card (for example, provided by LSI manufacturer), internal devices are arranged by the firmware in the order in which they are connected, while regarding external devices, the firmware detects all the external devices and arranges them according to the response time received from the external devices. However, the control chip (for example, from Vitesse) cannot resolve foregoing problem automatically. First, the firmware in the daughter card detects all the devices (for example, CD-ROM or other hard disks) connected to the host computer. Then, the firmware assigns SAS addresses (containing SCSI port, BUS, Lun, ScsiID etc) to each external storage device connected to the host computer through SAS technique according to the response time thereof, wherein the EM device and backplane device respectively have their own SAS address. Thus, these storage devices are displayed in the OS according to the information thereof obtained by the daughter card (i.e. the response time thereof) but not according to the actual order in which they are attached.

### SUMMARY OF THE INVENTION

Accordingly, the present invention is directed to a method for detecting the actual order of a plurality of attached devices.

The present invention is directed to a computer readable storage media for storing a computer program, wherein the computer program is loaded into a computer system for executing foregoing detecting method.

The present invention provides a method for detecting the order of a plurality of attached devices. The method includes following steps. First, an inquiry is issued to obtain the device information of these devices. Then, the addresses of these devices are respectively obtained from the device information to form a device listing. After that, an attached device address corresponding to each of the devices is respectively obtained from the device information. After that, the actual order of these devices is sorted and obtained according to the index relationship between the device listing and the attached device addresses in the device information.

According to an embodiment of the present invention, the attached device addresses are serial attached SCSI (SAS) addresses, and the command for issuing the inquiry contains the InQuary command in small computer system interface (SCSI) command set. The devices may include data storage devices and external hard disks, and the device information of each of the devices may contain the address of the device.

According to the present invention, the order of a plurality of attached devices is obtained by respectively checking the attached device address in the device information of each device, and the order in which these devices are selected is recorded so that the device information of these devices can be displayed in an OS in their actual attached order and accordingly a user can manage these external devices conveniently.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating a server externally connected with a plurality of hard disks according to an embodiment of the present invention.

FIG. 2 is a flowchart illustrating a method for detecting the order of a plurality of attached devices according to an embodiment of the present invention.

FIG. 3 lists the device information of a plurality of attached devices according to an embodiment of the present invention.

FIG. 4 illustrates a procedure for sorting a device listing according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

A method for detecting the order of a plurality of attached devices according to an embodiment of the present invention will be described below. Those having ordinary knowledge in the art may implement the following embodiment with a computer program (for example, software, firmware, etc) and store the computer program into a computer readable storage media (for example, hard disk, memory, etc) to be executed, so that the method for detecting the order of attached devices provided by the present invention can be carried out automatically.

According to the conventional technique, the firmware in a daughter card automatically detects the response time of a plurality of attached devices and assigns a serial attached SCSI (SAS) address to each of the devices, and the devices are arranged in the management system according the response time thereof, which is very inconvenient to use and manage. Accordingly, a method for detecting the actual order of the attached devices according to an embodiment of the present invention will be described below with reference to accompany drawings. The following embodiment will be implemented with the specification of SCSI enclosure services (SES)-2.

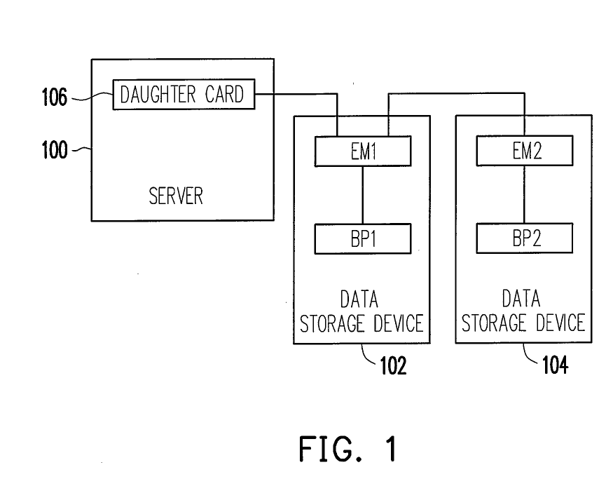

FIG. 1 is a block diagram illustrating a server externally connected with a plurality of hard disks according to the present embodiment. Referring to FIG. 1, the server 100 is attached with two data storage devices (for example, external hard disks Calamari) 102 and 104. The data storage device 102 includes an enclosure management (EM) device EM1 and a backplane (BP) device BP1. The data storage device 104 includes an EM device EM2 and a backplane device BP2.

In the present embodiment, the EM device EM1 and the BP device BP1 of the data storage device 102 may use the same type of management chip (for example, chip 7155), while the EM device EM2 and the BP device BP2 of the data storage device 104 may also use the same type of management chip. The management chips store related information of the devices and the attached devices thereof. For example, a chip 7155 has a diagnostic page at address 0x0ah, and this diagnostic page records the type of the device (for example, EM device, backplane device, CD-ROM etc), the SAS address of the device, and SAS addresses of attached devices. With the EM device EM1 as example, the diagnostic page of the management chip thereof records the device type of the EM device EM1, the SAS address thereof, and SAS addresses of the attached devices thereof (BP1 and EM2). Accordingly, in the present embodiment, the EM device EM1 stores the SAS addresses of EM device EM2 and backplane device BP1, and the backplane device BP1 stores the SAS address of the hard disk connected thereto. The EM device EM2 stores the SAS address of the backplane device BP2, and the backplane device BP2 stores the SAS address of the hard disk connected thereto.

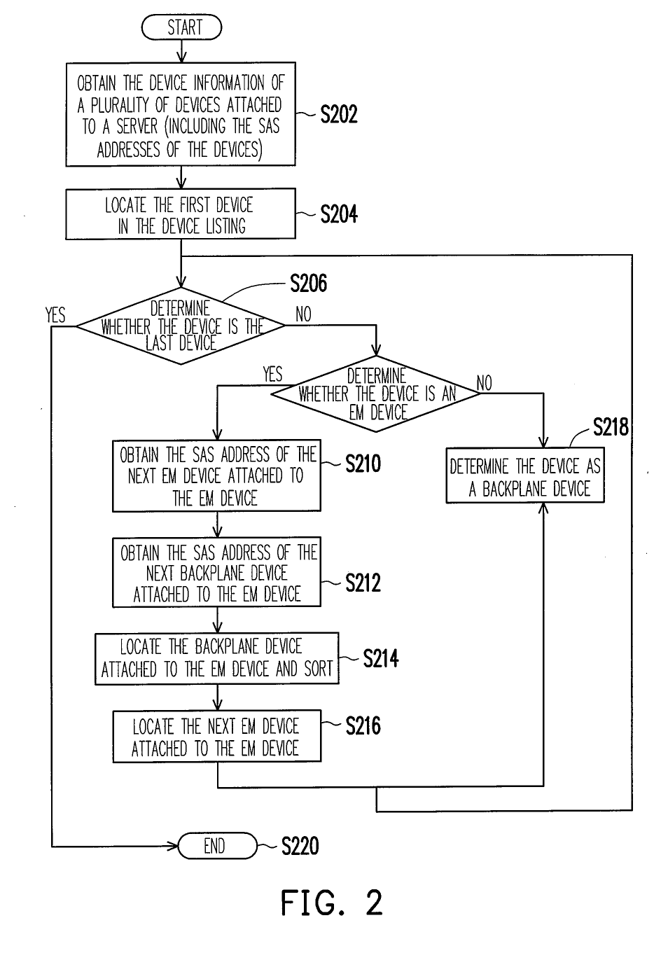

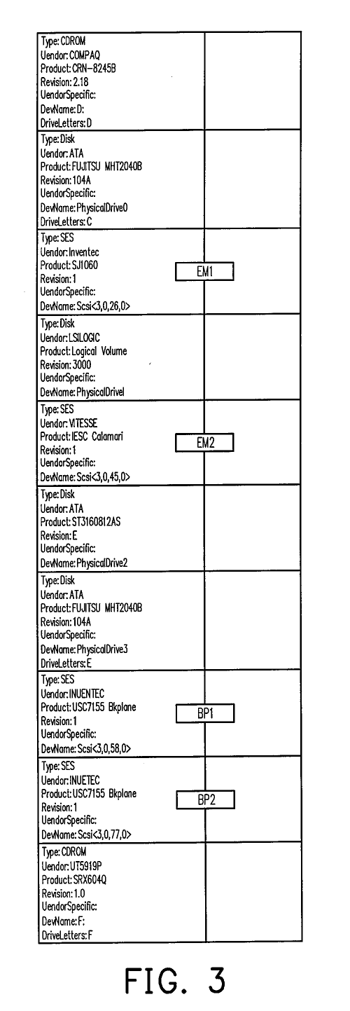

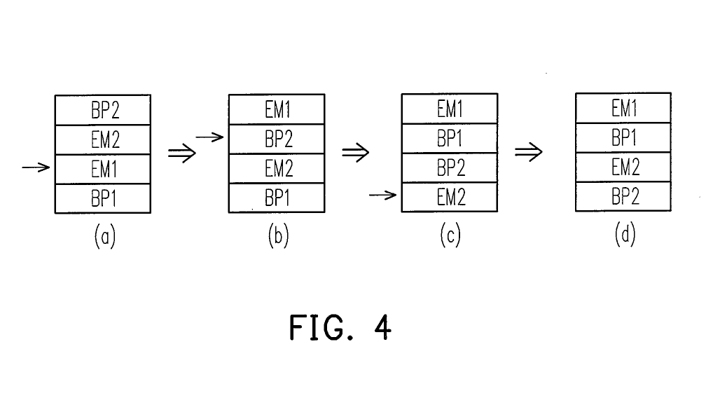

FIG. 2 is a flowchart illustrating the method for detecting the order of the attached devices in the present embodiment. Referring to both FIG. 1 and FIG. 2, first, in step S202, the firmware in the daughter card 106 of the server 100 issues an inquiry (for example, an InQuary command in SCSI command set) in order to obtain the device information of the devices attached to the server 100 (including the addresses of the devices). The address of each of the devices EM1, BP1, EM2, and BP2 can be obtained from the device information to form a device listing. The attached device address corresponding to each of the devices can be obtained from the device information. FIG. 3 illustrates part of the device information obtained by the server 100. As shown in FIG. 3, the information of all the devices obtained in step S202 by the server 100 also includes information provided by other devices (for example CD-ROM, disk etc) besides the EM devices EM1 and EM2 and the backplane devices BP1 and BP2. The server 100 can determine which devices support SES-2 according to the device information, and by filtering off those unneeded device information, only those devices which support SES-2 are kept in the device listing. In the present embodiment, the device listing contains the device information of the EM devices EM1 and EM2 and the backplane devices BP1 and BP2. Here it is assumed that the time of the EM devices EM1 and EM2 and the backplane devices BP1 and BP2 responding to the inquiry of the server 100 is in such an order: BP2, EM2, EM1, and BP1, thus the device listing is as shown in diagram (a) of FIG. 4.

The order of the devices can be sorted in accordance with the index relationship between the attached device addresses in the device information and the device listing. In step S202, the diagnostic pages in these devices defined according to SES-2 are further obtained according to the addresses (for example, SCSI port, Bus, Lun, ScsiID) of these devices in the device listing, so that the information (for example, SAS addresses) of these devices and the detached devices thereof can be obtained. Here the firmware in the daughter card 106 of the server 100 may execute a GetPage (SAS address, Page 1) command to obtain the content of the diagnostic pages of the devices in the device listing. With the EM device EM1 as example, the firmware in the daughter card 106 may execute GetPage(3, 0, 26, 0, Page 1) to obtain the content in the diagnostic page of the EM device EM1. In addition, the firmware in the daughter card 106 may further execute GetPage 10 to determine whether each device in the device listing is an EM or a backplane device.

Thereafter, in step S204, the first device is located according to the information obtained in step 202 in the device listing (as shown in diagram (a) of FIG. 4). A device can be selected as the first device of the device listing as long as the attached SAS addresses thereof are not in the device listing and the device is an EM device. In the present embodiment, since the attached SAS address of the EM device EM1 (i.e. the SAS address of the daughter card 106) is not in the device listing and EM1 is a EM device, the EM device EM1 is selected as the first device of the device listing in step S204 (as shown in diagram (b) of FIG. 4).

Next, in step S206, whether the EM device EM1 is the last device is determined. The EM device EM1 is determined not to be the last device as long as the attached device address of one of the devices in the device listing is the address of the EM device EM1. In the present embodiment, the EM device EM1 is not the last device and step S208 is then executed.

In step S208, whether the device EM1 is an EM device is determined, and here a command (for example, GetPage(SAS address, Page 10)) is further executed. In the present embodiment, step S210 is then executed since EM1 is an EM device.

In step S210, the SAS address of the next EM device attached to the EM device EM1 is located in the device listing. A device in the device listing is determined to be the next EM device attached to EM1 as long as the device is an EM device and the attached device address thereof is the address of the EM device EM1. In the present embodiment, the next EM device attached to EM1 is the EM device EM2, thus, the SAS address of the EM device EM2 is obtained in step S210.

Thereafter, in step S212, the SAS address of a backplane device attached to the EM device EM1 is located in the device listing. A device in the device listing is determined to be the backplane device attached to EM1 as long as the device is a backplane device and the attached device address thereof is the address of the EM device EM1. In the present embodiment, the backplane device attached to the EM device EM1 is BP1, thus, the SAS address of the backplane device BP1 is obtained in step S212.

Next, in step S214, the backplane device BP1 attached to EM1 is located in the device listing according to the SAS address obtained in step S212. For the convenience of users, BP1 is dragged behind EM1 in the device listing (as shown in diagrams (b) and (c) of FIG. 4).

After that, in step S216, the next EM device EM2 attached to EM1 is located in the device listing according to the SAS address obtained in step S210. Here from the point of view of a user, the attached order of these devices displayed in the OS should be the same as the actual order thereof. Thus, in the device listing in diagram (c) of FIG. 4, EM2 is dragged behind BP1 (as shown in diagram (d) of FIG. 4).

Thereafter, step S206 is executed again to determine whether the EM device EM2 is the last device. Since the attached device address of the backplane device BP2 in the device listing is the address of the EM device EM2, it is determined that the EM device EM2 is not the last device and step S208 is executed.

In step S208, whether the device EM2 is an EM device is determined. In the present embodiment, EM2 is an EM device, therefore step S210 is executed. In step S210, the SAS address of the next EM device attached to the EM device EM2 is located in the device listing. In the present embodiment, there is no EM device attached to the EM device EM2, therefore step S212 is executed. In step S212, the SAS address of the backplane device attached to the EM device EM2 is located in the device listing. In the present embodiment, the backplane device BP2 is attached to the EM device EM2, thus, the SAS address of the backplane device BP2 is obtained in step S212.

Next, in step S214, the backplane device BP2 attached to the EM device EM2 is located in the device listing according to the SAS address obtained in step S212. Accordingly, BP2 is dragged behind EM2 in the device listing (as shown in diagram (d) of FIG. 4). Next, in step S216, the next EM device attached to the EM device EM2 is located in the device listing according to the SAS address obtained in step S210. Since there is no more EM device attached to the EM device EM2, step S206 is executed.

In step S206, whether BP2 is the last device is determined. Since there is no more device in the device listing whose attached device address is the address of the backplane device BP2, the backplane BP2 is determined to be the last device and step S220 is executed to terminate the procedure.

In overview, according to the present invention, the actual order a plurality of attached devices can be displayed in a management system.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for detecting series connection order of a plurality of devices, comprising:
issuing an inquiry to obtain a plurality of device information from the devices;
respectively obtaining an address of each of the devices from the device information to form a device listing;
respectively obtaining a plurality of attached device addresses from the device information, wherein each of the attached device addresses is an address of other device attached from one of the devices;
sorting the series connection order of the devices according to relationship between the attached device addresses in the device information and the device listing.

2. The method according to claim 1, wherein the attached device address is a serial attached SCSI (SAS) address.

3. The detecting method according to claim 1, wherein the inquiry comprises an InQuary command in small computer system interface (SCSI) command set.

4. The method according to claim 1, wherein the devices comprise data storage devices.

5. The method according to claim 1, wherein the devices comprise external hard disks.

6. The method according to claim 1, wherein the step of sorting the series connection order of the devices according to the relationship between the attached device addresses in the device information and the device listing comprises:
locating one of the devices as first device in the device listing, wherein the attached device address of the first device in the device listing is not recorded in the device listing.

7. The method according to claim 6, wherein the step of sorting the series connection order of the devices according to the relationship between the attached device addresses in the device information and the device listing further comprises:
locating one of the device as second device in the device listing, wherein the attached device address of the second device in the device listing is the address of the first device in the device listing.

8. A computer readable storage media, for storing a computer program, wherein the computer program is suitable for being loaded into a computer system for executing the method in claim 1.
